(19) United States
(12) Patent Application Publication
(10) Pub. No.: US 2025/0175107 A1
(43) Pub. Date: May 29, 2025

(54) PROCESSOR, MOTOR CONTROL DEVICE AND CONTROL METHOD FOR CONTROLLING MOTOR

(71) Applicant: Industrial Technology Research Institute, Hsinchu (TW)

(72) Inventors: Hung-Yi Teng, Kaohsiung City (TW); Zhan-Bo Fang, Chiayi County (TW); Yan-Fu Jhou, Tainan City (TW)

(73) Assignee: Industrial Technology Research Institute, Hsinchu (TW)

(21) Appl. No.: 18/776,263

(22) Filed: Jul. 18, 2024

(30) Foreign Application Priority Data
Nov. 27, 2023 (TW) 112145900

(51) Int. Cl. H02P 23/00; G06N 3/092; H02P 23/14

(52) U.S. Cl. CPC H02P 23/0018; G06N 3/092; H02P 23/0077; H02P 23/14

(57) ABSTRACT

A processor for controlling a motor, a motor control device and a control method therefore are provided. The processor includes a feedback calculator, a control calculator and a drive calculator. The feedback calculator calculates a direct-axis current and a quadrature-axis current according to a drive current driving a motor and an operating angle of the motor. The control calculator includes a reinforcement learning controller. The reinforcement learning controller uses a reinforcement learning algorithm to calculate a direct-axis voltage and a quadrature-axis voltage according to a quadrature-axis current command, the direct-axis current and the quadrature-axis current. The quadrature-axis current command is obtained according to a reference rotational speed and the operating speed of the motor. The drive calculator generates a switching signal according to the direct-axis voltage, quadrature-axis voltage and an operating angle of the motor. The switching signal is used to control a driving circuit to drive the motor.

### CROSS-REFERENCE TO RELATED APPLICATION

This application claims the priority benefit of Taiwan application serial no. 112145900, filed on Nov. 27, 2023. The entirety of the above-mentioned patent application is hereby incorporated by reference herein and made a part of this specification.

### TECHNICAL FIELD

The disclosure relates to a processor, a motor control device, and a control method for controlling a motor.

### BACKGROUND

Present-day transportation tools are primarily being developed in the direction of electric vehicles or electrically powered auxiliary vehicles, and related technologies of electrically powered auxiliary vehicles possess diverse applications. The most critical aspects of an electric vehicle are its power supply and electric motor drive.

Electric motor drive technology often uses magnetic field-oriented control technology and proportional-integral-derivative (PID) controller to implement the drive and control of the electric motor. However, electric vehicles often face unpredictable dynamic changes in torque load, rotor resistance, or stator resistance. Moreover, different specifications of electric vehicle motors and different degrees of torque load changes all require individual tuning of parameters in the PID controller to optimize the drive control performance of the motor. Therefore, how to improve the magnetic field-oriented control technology and effectively enhance the control performance of electric motors is one of the research directions.

### SUMMARY

A processor, a motor control device, and a control method for controlling a motor, which may improve the overshoot problem in the proportional-integral-derivative (PID) controller and the time-consuming situation of parameter tuning, and reduce the tracking error of rotational speed and current in the motor, are provided in the disclosure.

The processor for controlling the motor of the embodiment of the disclosure includes a feedback calculator, a control calculator, and a drive calculator. The feedback calculator calculates a direct-axis current and a quadrature-axis current according to a drive current configured to drive the motor and an operating angle of the motor. The control calculator is coupled to the feedback calculator. The control calculator includes a reinforcement learning controller. The reinforcement learning controller uses a reinforcement learning algorithm to calculate a direct-axis voltage and a quadrature-axis voltage according to a quadrature-axis current command, the direct-axis current, and the quadrature-axis current. The quadrature-axis current command is obtained according to a reference rotational speed and the operating speed of the motor. The drive calculator is coupled to the control calculator. The drive calculator generates a switching signal according to the direct-axis voltage, the quadrature-axis voltage, and the operating angle. The switching signal is configured to control a driving circuit to drive the motor.

The motor control device according to the embodiment of the disclosure includes a processor, a driving circuit, and a sensor. The driving circuit is coupled to the processor and controlled by the processor to drive the motor. The sensor is coupled to the processor. The sensor is configured to sense an operating speed and an operating angle of the motor. The processor controls the driving circuit according to the drive current of the driving circuit, the operating speed and the operating angle of the motor. The processor includes a feedback calculator, a control calculator, and a drive calculator. The feedback calculator calculates a direct-axis current and a quadrature-axis current according to the drive current and the operating angle of the motor. The control calculator is coupled to the feedback calculator. The control calculator includes a reinforcement learning controller. The reinforcement learning controller uses a reinforcement learning algorithm to calculate a direct-axis voltage and a quadrature-axis voltage according to a quadrature-axis current command, the direct-axis current, and the quadrature-axis current. The quadrature-axis current command is obtained according to a reference rotational speed and the operating speed of the motor. The drive calculator is coupled to the control calculator. The drive calculator generates a switching signal according to the direct-axis voltage, the quadrature-axis voltage, and the operating angle. The switching signal is configured to control a driving circuit to drive the motor.

The control method for a motor according to the embodiment of the disclosure includes the following operation. Operating speed and operation angle of the motor are sensed. A direct-axis current and a quadrature-axis current are calculated according to a drive current driving a motor and an operating angle. A direct-axis voltage and a quadrature-axis voltage are calculated according to a quadrature-axis current command, the direct-axis current, and the quadrature-axis current by using a reinforcement learning algorithm. The quadrature-axis current command is obtained according to a reference rotational speed and the operating speed of the motor. A switching signal is generated according to the direct-axis voltage, the quadrature-axis voltage and the operating angle. The switching signal is configured to control a driving circuit to drive the motor.

Based on the above, the processor, the motor control device and the control method for controlling a motor of the embodiment of the disclosure adopt a reinforcement learning calculator and a reinforcement learning algorithm applied to motor control in the current loop of the PID controller, use the PDFF controller in the control calculator in the speed loop of the PID controller to improve the overshoot problem in the PID controller and improve the time-consuming situation of parameter tuning, and adjust the transient response speed through the feedforward proportional coefficient in the PDFF controller to reduce the tracking error of the rotational speed and current in the motor. In this way, the control performance of the controlled motor may be effectively improved.

### BRIEF DESCRIPTION OF THE DRAWINGS

FIG. 1 is a schematic diagram of a motor control device according to the first embodiment of the disclosure.

FIG. 2A and FIG. 2B are schematic diagrams of using a reinforcement learning controller to implement a reinforcement learning algorithm according to the first embodiment of the disclosure.

FIG. 3 is a schematic diagram of a motor control device according to the second embodiment of the disclosure.

FIG. 4 is a schematic diagram of the PDFF controller in FIG. 3 configured to calculate the quadrature-axis current command.

FIG. 5 is a schematic diagram of a current loop performance comparison between the processor in the first embodiment of FIG. 1 and the PID controller implemented by adopting a PI controller.

FIG. 6 is a schematic diagram of a speed loop performance comparison between the processor in the first embodiment of FIG. 1 and the PID controller implemented by adopting a PI controller.

FIG. 7 is a schematic diagram of a speed loop performance comparison between the processor in the second embodiment of FIG. 3 and the PID controller implemented by adopting a PI controller.

FIG. 8 is a flowchart of a control method for a motor according to an embodiment of the disclosure.

### DETAILED DESCRIPTION OF DISCLOSED EMBODIMENTS

Proportional-integral-derivative (PID) controllers often use multiple proportional-integral (PI) controllers to implement the current loop and speed loop in the PID controller, but there are often large overshoots in the voltage commands generated by the PID controller, and the adaptability to the overall system parameters and external disturbances in the motor control device is poor. “Current loop” means that the PID controller sets the external output torque of the motor shaft through external data input or simulation. It is applied in situations where the motor torque needs to be strictly controlled as a current loop control. “Speed loop” means that the PID controller controls the rotational speed of the motor through external data input or simulation.

The embodiment of the present invention adopts a reinforcement learning calculator and a reinforcement learning algorithm applied to motor control in the current loop of the proportional-integral-derivative (PID) controller, uses the pseudo-derivative feedback with feedforward gain (PDFF) controller in the control calculator in the speed loop of the PID controller to improve the overshoot problem in the PID controller and improve the time-consuming situation of parameter tuning, thereby enhancing the control performance of the controlled motor. Several embodiments are provided below for further explanation.

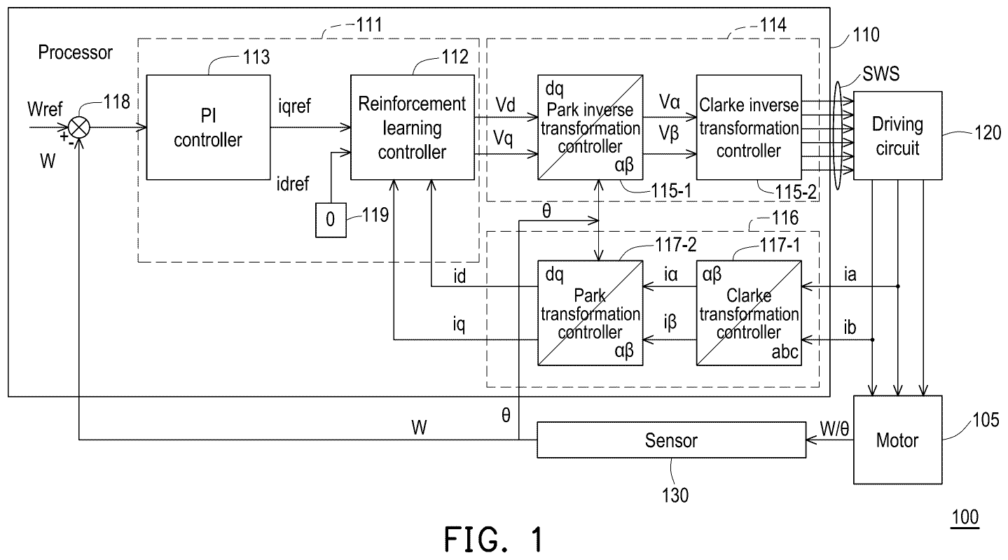

FIG. 1 is a schematic diagram of a motor control device 100 according to the first embodiment of the disclosure. The motor control device 100 is configured to drive the motor 105. The motor 105 in this embodiment is a permanent-magnet synchronous motor (PMSM) as an example. The motor control device 100 mainly includes a processor 110, a driving circuit 120, and a sensor 130.

The processor 110 may be implemented using logic circuits. For example, the processor 110 may be a microprocessor. The driving circuit 120 is coupled to the processor 110 and the motor 105. The driving circuit 120 is controlled by the processor 110 to drive the motor 105. The sensor 130 is coupled to the processor 110 and the motor 105. The sensor 130 senses the operating speed W and the operating angle θ of the motor 105 and provides the operating speed W and the operating angle θ to the processor 110. The operating speed W is the rotational speed of the motor, and its unit may be revolutions per minute (RPM). The processor 110 generates a switching signal SWS according to the drive current of the driving circuit 120 (e.g., the drive currents ia and ib in FIG. 1), and the operating speed W and the operating angle θ of the motor 105, and controls the driving circuit 120 through the switching signal SWS. The driving circuit 120 generates a corresponding drive current according to the switching signal to drive the motor 105.

The processor 110 mainly includes a control calculator 111, a drive calculator 114, and a feedback calculator 116. The feedback calculator 116 performs coordinate conversion on the current according to the drive current (e.g., the drive currents ia and ib in FIG. 1) configured to drive the motor 105 and the operating angle θ of the motor 105 to calculate the direct-axis current id and the quadrature-axis current iq.

In detail, the feedback calculator 116 includes a Clarke transformation controller 117-1 and a Park transformation controller 117-2. The Clarke transformation controller 117-1 converts the drive current (e.g., the drive currents ia and ib in FIG. 1) located in the time domain coordinate system into the first current iα and the second current iβ located in the orthogonal stationary coordinate system (expressed by αβ). The Park transformation controller 117-2 is coupled to the Clarke transformation controller 117-1. The Park transformation controller 117-2 converts the first current iα and the second current iβ located in the orthogonal stationary coordinate system (expressed by αβ) into the direct-axis current id and the quadrature-axis current iq located in the orthogonal rotational coordinate system (expressed by dq).

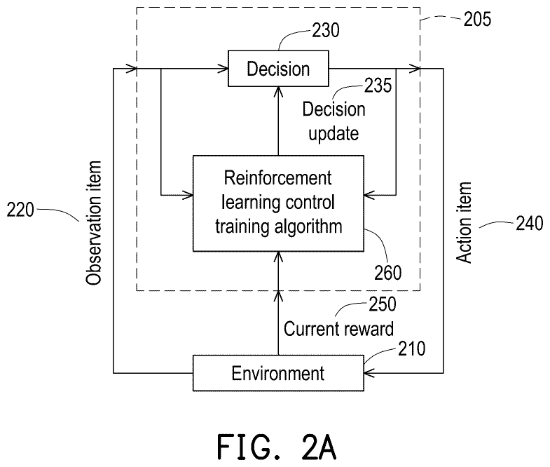

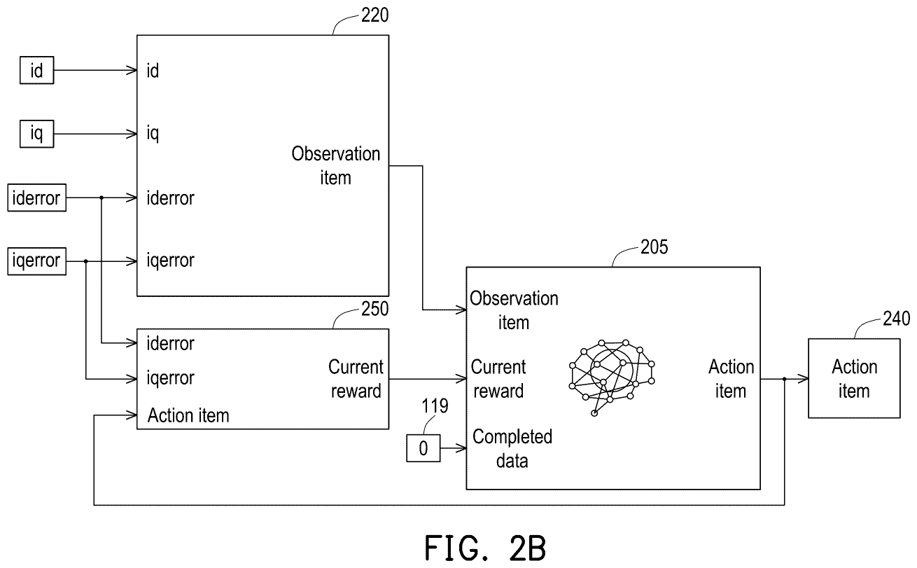

The control calculator 111 is coupled to the feedback calculator 116. The control calculator 111 may include a reinforcement learning controller 112 and a proportional-integral (PI) controller 113. The reinforcement learning controller 112 uses a reinforcement learning algorithm of the embodiment of the disclosure to calculate the direct-axis voltage Vd and the quadrature-axis voltage Vq according to the quadrature-axis current command iqref, the direct-axis current id, and the quadrature-axis current iq. Details related to the reinforcement learning controller 112 and the reinforcement learning algorithm are shown in FIG. 2A and FIG. 2B and corresponding descriptions below.

The quadrature-axis current command iqref in this embodiment is obtained according to the reference rotational speed Wref and the operating speed W of the motor 105. In detail, in the first embodiment of the disclosure, the PI controller 113 and the subtractor 118 are used to generate the quadrature-axis current command iqref according to the difference between the operating speed W and the reference rotational speed Wref Those who apply this embodiment may also use other methods to generate the quadrature-axis current command iqref, as long as the quadrature-axis current command iqref is obtained according to the reference rotational speed Wref and the operating speed W of the motor 105.

The drive calculator 114 is coupled to the control calculator 111. The drive calculator 114 generates the switching signal SWS according to the direct-axis current id, the quadrature-axis current iq, and the operating angle θ. The switching signal SWS is configured to control the driving circuit 120 to drive the motor 105. In detail, the drive calculator 114 includes a Park inverse transformation controller 115-1 and a Clarke inverse transformation controller 115-2. The Park inverse transformation controller 115-1 converts the direct-axis voltage Vd and the quadrature-axis voltage Vq located in the orthogonal rotational coordinate system dq into the first voltage Vα and the second voltage Vβ located in the orthogonal stationary coordinate system αβ. The Clarke inverse transformation controller 115-2 is coupled to the Park inverse transformation controller 115-1. The Clarke inverse transformation controller 115-2 converts the first voltage Vα and the second voltage Vβ located in the orthogonal stationary coordinate system αβ into the switching signal SWS.

The processor 110 further includes a subtractor 118 and a zero current supplier 119. The subtractor 118 subtracts the operating speed W and the reference rotational speed Wref to generate a difference between the operating speed W and the reference rotational speed Wref, and provides the difference to the PI controller 113. The zero current supplier 119 is coupled to the reinforcement learning controller 112. The zero current supplier 119 is configured to provide zero current as the direct-axis current command idref. The reinforcement learning controller 112 may use a reinforcement learning algorithm to calculate the direct-axis voltage Vd and the quadrature-axis voltage Vq according to the quadrature-axis current command iqref, the direct-axis current command idref, the direct-axis current id, and the quadrature-axis current iq. In this embodiment, the direct-axis current command idref is set to the zero current provided by the zero current supplier 119.

FIG. 2A and FIG. 2B are schematic diagrams of using a reinforcement learning controller 112 to implement a reinforcement learning algorithm according to the first embodiment of the disclosure. FIG. 2A shows a schematic diagram of the relationship between the environment 210, the observation item 220, the action item 240, the decision 230, and the reinforcement learning algorithm 205. The reinforcement learning algorithm 205 is an effective method for solving sequential decision problems. The reinforcement learning algorithm 205 may also be referred to as an intelligent entity. The environment 210 is a world that interacts with the intelligent entity. In every interaction, the intelligent entity obtains the observation item 220 of the state of the environment 210, and then decides on the next action to be executed according to the decision 230. The environment 210 may change due to the actions of the intelligent entity, or it may change autonomously. The intelligent entity also perceives a current reward 250 from the environment that indicates whether the current state is good or bad. The goal of the intelligent entity is to maximize the current reward accumulation.

As shown in FIG. 2A, the reinforcement learning algorithm 205 mainly includes a decision 230 and a reinforcement learning control training algorithm 260. The decision 230 is an equation that is self-adjusted by the reinforcement learning algorithm 205, so the decision 230 may also be referred to as a decision equation. The reinforcement learning control training algorithm 260 is an operational logic algorithm and corresponding technology used to adjust the decision equation. The reinforcement learning algorithm 205 is a technology in which an intelligent entity continuously corrects its own decision 230 through learning behavior to achieve its goals.

In this embodiment, the following four values are mainly observed under the environment 210 as the observation items 220: the direct-axis current id, the quadrature-axis current iq, the direct-axis current error value iderror generated from the difference between the current direct-axis current id and the previous direct-axis current, and the quadrature-axis current error value iqerror generated from the difference between the current quadrature-axis current iq and the previous quadrature-axis current. The direct-axis voltage Vd and the quadrature-axis voltage Vq are action items 240 of the reinforcement learning algorithm.

The input of the reinforcement learning algorithm 205 is mainly the values in the observation item 220, and the output of the reinforcement learning algorithm 205 is the values in the action item 240. The decision 230 in the reinforcement learning algorithm 205 mainly uses each value in the observation item 220 for calculation and converts it into each value in the action item 240. The reinforcement learning control training algorithm 260 in the reinforcement learning algorithm 205 determines whether to perform the decision update 235 according to the current reward 250, and determines the degree of adjustment to the decision update 235.

FIG. 2A calculates the current reward 250 based on the reward equation, corresponding data from the current observation item 220 and the current action item 240. In detail, the current reward (rt) 250 may be calculated by the following reward equation (1):

$$rt = - ( Q 1 \times {iderror}^{2} + Q 2 \times {iqerror}^{2} + R \times {\sum }_{j} {( {u}_{t - 1}^{j} )}^{2} ) \qquad ( 1 )$$

“iderror” in the reward equation (1) is the aforementioned direct-axis current error value, “iqerror” is the aforementioned quadrature-axis current error value, Q1, Q2 and R are the default parameters, and “rt” is the current reward 250. “j” represents the action index. (uₜ₋₁^{j}) is the action of the previous time step. In this embodiment, Q1 and Q2 are set to 5, and R is set to 0.1. Those who apply this embodiment may adjust the preset parameters such as Q1, Q2, and R according to their requirements.

FIG. 2B is a schematic diagram of using simulation software (e.g., MATLAB/Simulink) to present the reinforcement learning algorithm with multiple functional blocks. The observation item 220 in FIG. 2B includes the direct-axis current id, the quadrature-axis current iq, the direct-axis current error value iderror, and the quadrature-axis current error value iqerror. The current reward 250 is mainly calculated from the direct-axis current error value iderror, the quadrature-axis current error value iqerror, and the previous action item 240. The reinforcement learning algorithm 205 calculates the estimated action item 240 from the aforementioned observation item 220, the current reward 250 and the completed data (e.g., the direct-axis current command idref as the zero current provided by the zero current supplier 119). The reinforcement learning algorithm 205 of this embodiment may also be referred to as twin delayed deep deterministic policy gradients (TD3).

Those who apply this embodiment may use different types of reinforcement learning algorithms to implement the reinforcement learning controller 112 in FIG. 1 according to their requirements. An example is provided here to illustrate the training steps of the reinforcement learning control training algorithm 260 in FIG. 2A. The training steps of the reinforcement learning control training algorithm 260 may be mainly divided into steps 1 to 6.

In step 1, a specific action item is selected. In this embodiment, action A is selected and presented by the following equation (2):

$$A = μ ( S ) + N \qquad ( 2 )$$

“S” in equation (2) corresponding to action A is the current state, and “N” is random noise.

After selecting a specific action item (i.e., action A), the second step (step 2) is performed. Step 2 includes the following sub-steps 1 to 3. In sub-step 1, the selected action A is executed to generate an action value AV. In sub-step 2, the aforementioned current reward rt is calculated based on the aforementioned reward equation (1). In sub-step 3, the corresponding state of the next observation item is calculated as state data S′. After executing sub-steps 1 to 3, the current state S, action value AV, current reward rt, and state data S′ are stored as a set of training patterns, and a set of training patterns is presented here as (S, AV, rt, S′).

In step 3, the aforementioned step 2 is executed multiple times (e.g., the aforementioned step 2 is executed M times, M is a positive integer) to randomly generate multiple sets of training patterns.

In step 4, multiple value function targets yi are calculated based on the multiple sets of training patterns. The equation (3) of the value function target yi is presented as follows:

$$yi = Ri + γ \cdot min ( {Qk}^{′} ( {Sk}^{ 40} , clip ( {μ}^{′} ( {Sk}^{′} \vert θ u ) + ε ) \vert {θ}_{{Qk}^{′}} ) ) \qquad ( 3 )$$

In equation (3), “Ri” is the reward, and the value function target yi is the sum of the reward Ri and the minimum discounted future reward of critics. “Qk′” is the action value function for policy k. “Sk′” is the state for policy k. “θu” represents a parameter configured to indicate asynchronous work items. “θ_{Qk′}” represents the action value function in asynchronous work items.

In step 5, parameter of each critic is updated to minimize the parameter Lk. The equation (4) of parameter Lk is presented as follows:

$$Lk = \frac{1}{M} {\sum }_{i = 1}^{M} {( yi - Qk ( Si , Ai \vert {θ}_{Q k} ) )}^{2} \qquad ( 4 )$$

In equation (3), “Qk” is the action value function for policy k, “Si” is the state, and “Ai” is the action. [symbol] represents the action value function in asynchronous work items.

In step 6, the parameters in action A are updated to maximize the reward. The equation (5) for maximizing the reward is presented as follows:

$${∇}_{{θ}_{u}} J = \frac{1}{M} {\sum }_{i = 1}^{M} {G}_{ai} {G}_{ui} \qquad ( 5 )$$

The corresponding equation (6) for the parameter Gₐᵢ in equation (5) is presented as follows:

$${G}_{ai} = {∇}_{A} min ( {Q}_{k} ( {S}_{i} , {A}_{i} \vert {θ}_{Q} ) ) ) \qquad ( 6 )$$

The corresponding equation (7) for the parameter Gᵤᵢ in equation (5) is presented as follows:

$${G}_{ui} = {∇}_{{θ}_{u}} μ ( {S}_{i} \vert {θ}_{μ} ) \qquad ( 7 )$$

The corresponding equation (8) for the parameter A in equation (6) is presented as follows:

$$A = μ ( {S}_{i} \vert {θ}_{μ} ) \qquad ( 8 )$$

After executing steps 1 to 6, the reinforcement learning control training algorithm 260 in FIG. 2A may correspondingly adjust the equations in the decision 230 through the decision update 235, thereby realizing the function of the deep neural network.

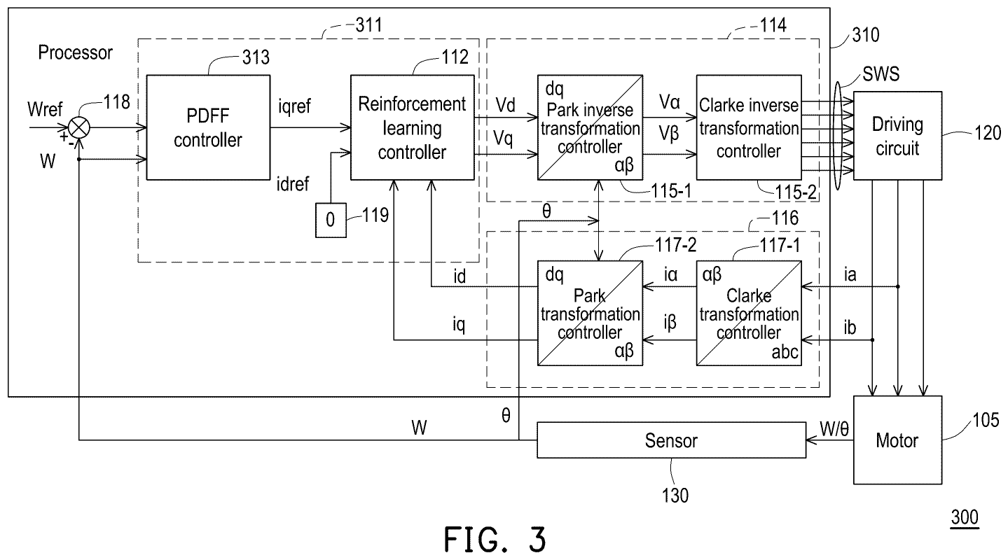

FIG. 3 is a schematic diagram of a motor control device 300 according to the second embodiment of the disclosure. The main difference between FIG. 1 and FIG. 3 is that in the second embodiment, a pseudo-derivative feedback with feedforward gain (PDFF) controller 313 and a subtractor 118 in the processor 310 are used to generate the quadrature-axis current command iqref based on the operating speed W and the reference rotational speed Wref. Specifically, the PDFF controller 313 calculates the quadrature-axis current command iqref according to the reference rotational speed Wref and the operating speed W of the motor.

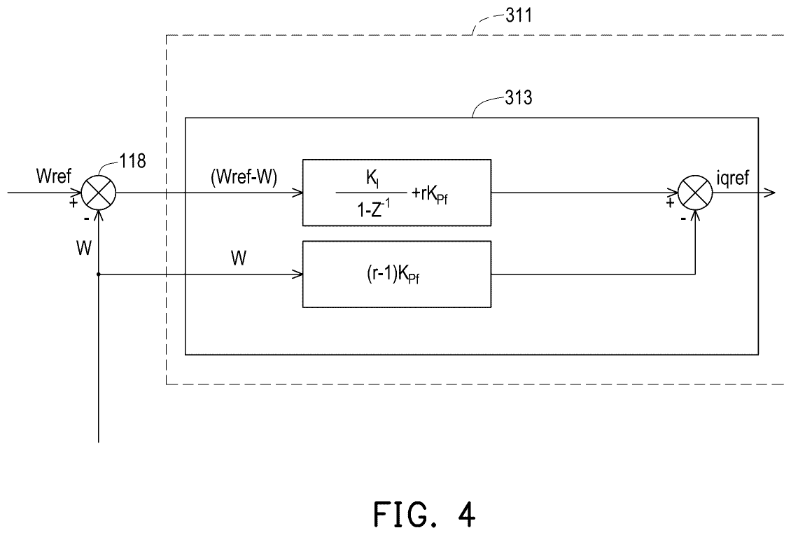

FIG. 4 is a schematic diagram of the PDFF controller 313 in FIG. 3 configured to calculate the quadrature-axis current command iqref. The PDFF controller 313 calculates the quadrature-axis current command iqref according to the following equation (9):

$$iqref = ( Wref - W ) \times ( \frac{KI}{1 - {Z}^{- 1}} + r \times Kpf ) + W \times ( r - 1 ) \times Kpf \qquad ( 9 )$$

“W” is the operating speed of the motor, “Wref” is the preset reference rotational speed in this embodiment, “r” is the feedforward proportional coefficient, “Kpf” is the feedback proportional gain, “KI” is the integral gain,

$$“ \frac{KI}{1 - {Z}^{- 1}} ”$$

is the Z conversion value of the integral gain, and “iqref” is the quadrature-axis current command.

The equation (9) in the PDFF controller 313 is applied to the processor 310 (e.g., PID controller) in a preset formula form, and the aforementioned equation (9) does not require training. Therefore, in this embodiment, in the speed loop of the PID controller, the quadrature-axis equivalent current command (e.g., quadrature-axis current command iqref) output by the PDFF controller 313 is adopted, which may effectively eliminate overshoot and adjust the transient response speed through multiple gains and coefficients (e.g., feedforward proportional coefficient r, feedback proportional gain Kpf, integral gain KI . . . etc.), thereby reducing the tracking error of input data.

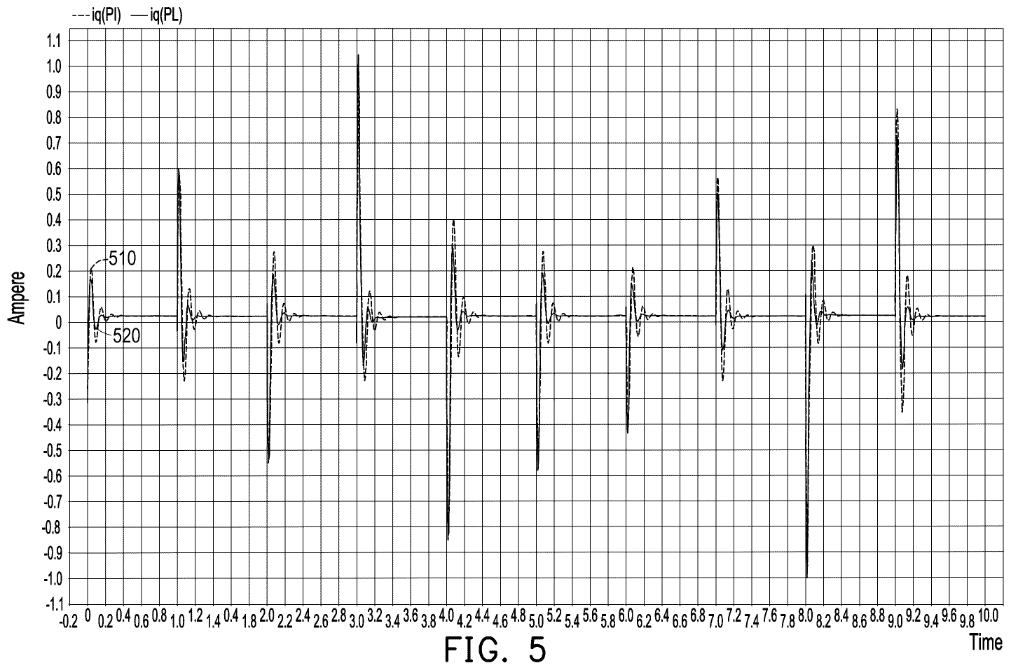

FIG. 5 is a schematic diagram of a current loop performance comparison between the processor 110 in the first embodiment of FIG. 1 and the PID controller implemented by adopting a PI controller. In FIG. 5, the horizontal axis is time, and the vertical axis is the measured quadrature-axis current value error (in amperes). It may be seen from FIG. 5 that the waveform 510 (represented by a solid line) corresponding to the quadrature-axis current value error of the processor 110 adopting the reinforcement learning controller 112 shown in FIG. 1 exhibits significantly less fluctuation than the waveform 520 (represented by a dashed line) corresponding to the quadrature-axis current value error generated by the PID controller implemented with the PI controller. After simulation, the processor 110 adopting the reinforcement learning controller 112 in FIG. 1 may reduce the quadrature-axis current value error by greater than or equal to 30%.

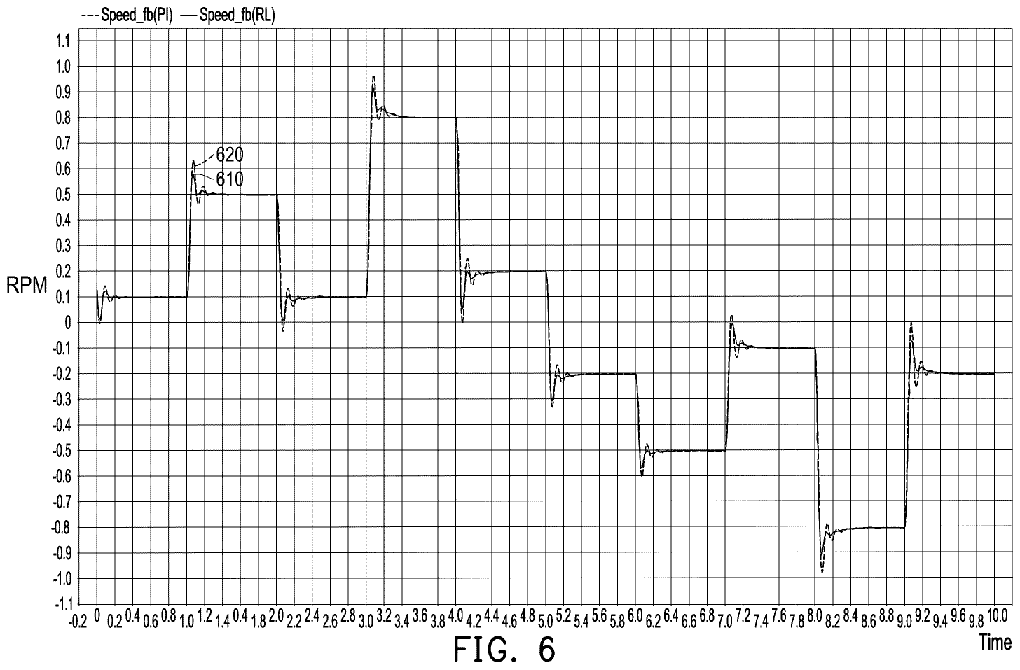

FIG. 6 is a schematic diagram of a speed loop performance comparison between the processor 110 in the first embodiment of FIG. 1 and the PID controller implemented by adopting a PI controller. In FIG. 6, the horizontal axis is time, and the vertical axis is the measured operating speed (in revolutions per minute (RPM)). It may be seen from FIG. 6 that the waveform 610 (represented by a solid line) between the operating speed and the estimated rotational speed of the processor 110 adopting the reinforcement learning controller 112 shown in FIG. 1 exhibits significantly less fluctuation than the waveform 620 (represented by a dashed line) between the operating speed and the estimated rotational speed corresponding to the PID controller implemented with the PI controller. After simulation, the processor 111 adopting the reinforcement learning controller 112 in FIG. 1 may reduce the speed error by greater than or equal to 10%.

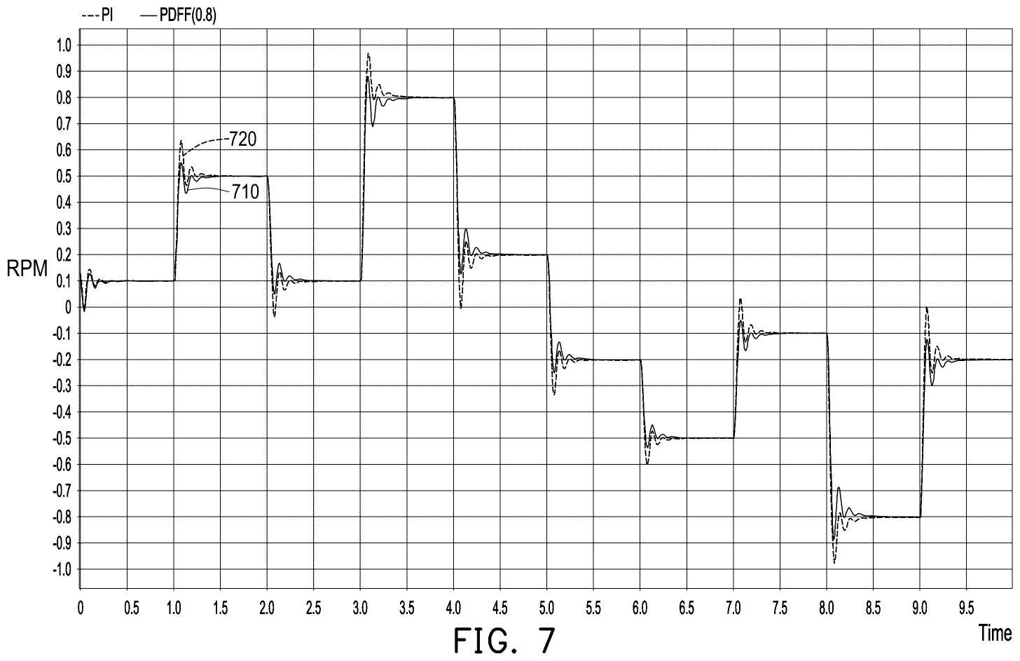

FIG. 7 is a schematic diagram of a speed loop performance comparison between the processor 311 in the second embodiment of FIG. 3 and the PID controller implemented by adopting a PI controller. In FIG. 7, the horizontal axis is time, and the vertical axis is the measured operating speed (in revolutions per minute (RPM)). It may be seen from FIG. 7 that the waveform 710 (represented by a solid line) between the operating speed and the estimated rotational speed of the processor 310 adopting the PDFF controller 313 and the reinforcement learning controller 112 shown in FIG. 3 exhibits significantly less fluctuation than the waveform 720 (represented by a dashed line) between the operating speed and the estimated rotational speed corresponding to the PID controller implemented with the PI controller. After simulation, the processor 310 adopting the PDFF controller 313 and the reinforcement learning controller 112 in FIG. 3 may reduce the speed error by greater than or equal to 30%.

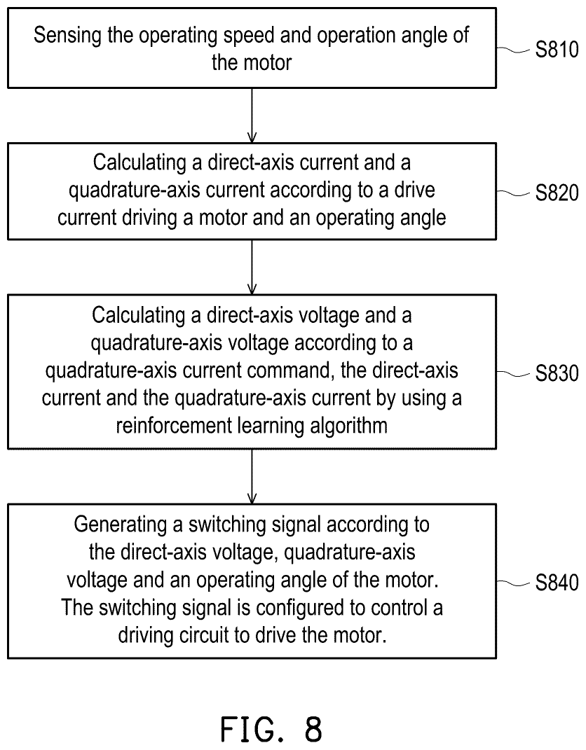

FIG. 8 is a flowchart of a control method for a motor according to an embodiment of the disclosure. The control method described in FIG. 8 may be applied to the corresponding hardware structure of the first embodiment of FIG. 1 or the corresponding hardware structure of the second embodiment of FIG. 3. Here, the control method of FIG. 8 is explained using FIG. 1 in combination with FIG. 8. In step S810, the sensor 130 in FIG. 1 is used to sense the operating speed W and the operating angle θ of the motor 105. In step S820, the processor 110 of FIG. 1 is used to calculate the direct-axis current id and the quadrature-axis current iq according to the drive current configured to drive the motor 105 (e.g., the drive currents ia, ib of FIG. 1) and the operating angle θ.

In step S830, the reinforcement learning controller 112 in the processor 110 of FIG. 1 is used and the reinforcement learning algorithm is used to calculate the direct-axis voltage Vd and the quadrature-axis voltage Vq according to the quadrature-axis current command iqref, the direct-axis current id, and the quadrature-axis current iq. The quadrature-axis current command iqref is obtained by using the PI controller 113 in FIG. 1 (or the PDFF controller 313 in FIG. 3) according to the reference rotational speed Wref and the operating speed W of the motor 105. In step S840, the processor 110 of FIG. 1 is used to generate the switching signal SWS according to the direct-axis voltage Vd, the quadrature-axis voltage Vq, and the operating angle θ. The switching signal SWS is configured to control the driving circuit 120 to drive the motor 105.

For detailed procedures of steps S810 to S840 of the control method in FIG. 8, please refer to the aforementioned embodiments.

To sum up, the processor, the motor control device and the control method for controlling a motor of the embodiment of the disclosure adopt a reinforcement learning calculator and a reinforcement learning algorithm applied to motor control in the current loop of the PID controller, use the PDFF controller in the control calculator in the speed loop of the PID controller to improve the overshoot problem in the PID controller and improve the time-consuming situation of parameter tuning, and adjust the transient response speed through the feedforward proportional coefficient in the PDFF controller to reduce the tracking error of the rotational speed and current in the motor. In this way, the control performance of the controlled motor may be effectively improved.

What is claimed is:

1. A processor for controlling a motor, comprising:
a feedback calculator, calculating a direct-axis current and a quadrature-axis current according to a drive current configured to drive the motor and an operating angle of the motor;
a control calculator, coupled to the feedback calculator, the control calculator comprising a reinforcement learning controller, wherein the reinforcement learning controller uses a reinforcement learning algorithm to calculate a direct-axis voltage and a quadrature-axis voltage according to a quadrature-axis current command, the direct-axis current, and the quadrature-axis current, wherein the quadrature-axis current command is obtained according to a reference rotational speed and an operating speed of the motor; and
a drive calculator, coupled to the control calculator, generating a switching signal according to the direct-axis voltage, the quadrature-axis voltage, and the operating angle,
wherein the switching signal is configured to control a driving circuit to drive the motor.

2. The processor according to claim 1, wherein the reinforcement learning algorithm uses the direct-axis current, the quadrature-axis current, a direct-axis current error value, and a quadrature-axis current error value as observation item of the reinforcement learning algorithm, uses a previous one of the direct-axis voltage and the quadrature-axis voltage as action item of the reinforcement learning algorithm, calculates a current reward according to a corresponding data of the observation item and the action item based on a reward equation, and calculates an estimated action item according to the observation item, the current reward, and completed data based on a decision equation in the reinforcement learning algorithm and a reinforcement learning control training algorithm, wherein the estimated action item comprises the direct-axis voltage and the quadrature-axis voltage.

3. The processor according to claim 2, wherein the reward equation is:
$$rt = - ( Q 1 \times {iderror}^{2} + Q 2 \times {iqerror}^{2} + R \times {\sum }_{j} {( {u}_{t - 1}^{j} )}^{2} )$$
wherein, iderror is the direct-axis current error value, iqerror is the quadrature-axis current error value, Q1, Q2 and R are default parameters, and rt is the current reward.

4. The processor according to claim 1, wherein training steps of the reinforcement learning control training algorithm comprises:
selecting a first action, the first action comprising current state and random noise;
executing a second step, the second step comprising executing the second action to generate an action value, calculating the current reward based on the reward equation, calculating a corresponding state of a next observation item as state data, and storing the current state, the action value, the current reward and the state data as a set of training patterns;
executing the second step multiple times to randomly generate multiple sets of training patterns;
calculating a plurality of value function targets based on the sets of training patterns; and
correcting comment parameters in a neural network based on the sets of training patterns and the value function targets to train the reinforcement learning control training algorithm.

5. The processor according to claim 1, wherein the control calculator further comprises:
a pseudo-derivative feedback with feedforward gain controller, coupled to the reinforcement learning controller and calculating the quadrature-axis current command according to the reference rotational speed and the operating speed of the motor.

6. The processor according to claim 5, wherein the pseudo-derivative feedback with feedforward gain controller calculates the quadrature-axis current command according to a following equation:
$$iqref = ( Wref - W ) \times ( \frac{KI}{1 - {Z}^{- 1}} + r \times Kpf ) + W \times ( r - 1 ) \times Kpf$$
wherein, W is the operating speed of the motor, Wref is the reference rotational speed, r is a feedforward proportional coefficient, Kpf is a feedback proportional gain, KI is an integral gain, Z⁻¹ is a Z conversion value, and iqref is the quadrature-axis current command.

7. The processor according to claim 1, wherein the reinforcement learning algorithm is twin delayed deep deterministic policy gradients (TD3) algorithm.

8. The processor according to claim 1, wherein the feedback calculator comprises:
a Clarke transformation controller, converting the drive current located in a time domain coordinate system into a first current and a second current located in an orthogonal stationary coordinate system; and
a Park transformation controller, coupled to the Clarke transformation controller, converting the first current and the second current located in the orthogonal stationary coordinate system into the direct-axis current and the quadrature-axis current located in an orthogonal rotational coordinate system.

9. The processor according to claim 7, wherein the drive calculator comprises:
a Park inverse transformation controller, converting the direct-axis voltage and the quadrature-axis voltage located in the orthogonal rotational coordinate system into a first voltage and a second voltage located in the orthogonal stationary coordinate system; and
a Clarke inverse transformation controller, coupled to the Park inverse transformation controller, converting the first voltage and the second voltage located in the orthogonal stationary coordinate system into the switching signal.

10. The processor according to claim 1, further comprising:
a zero current supplier, coupled to the reinforcement learning controller, configured to provide zero current as a direct-axis current command,
wherein the reinforcement learning controller uses the reinforcement learning algorithm to calculate the direct-axis voltage and the quadrature-axis voltage according to the quadrature-axis current command, the direct-axis current command, the direct-axis current, and the quadrature-axis current.

11. A motor control device, comprising:
a processor;
a driving circuit, coupled to the processor and controlled by the processor to drive a motor; and
a sensor, coupled to the processor, configured to sense an operating speed of the motor and an operating angle,
wherein the processor controls the driving circuit according to a drive current of the driving circuit, the operating speed of the motor and the operating angle,
wherein the processor comprises:
a feedback calculator, calculating a direct-axis current and a quadrature-axis current according to the drive current and the operating angle of the motor;
a control calculator, coupled to the feedback calculator, the control calculator comprising a reinforcement learning controller, wherein the reinforcement learning controller uses a reinforcement learning algorithm to calculate a direct-axis voltage and a quadrature-axis voltage according to a quadrature-axis current command, the direct-axis current, and the quadrature-axis current, wherein the quadrature-axis current command is obtained according to a reference rotational speed and the operating speed of the motor; and
a drive calculator, coupled to the control calculator, generating a switching signal according to the direct-axis voltage, the quadrature-axis voltage, and the operating angle, wherein the switching signal is configured to control the driving circuit.

12. The motor control device according to claim 11, wherein the reinforcement learning controller uses the reinforcement learning algorithm to calculate the direct-axis voltage and the quadrature-axis comprises:
using the direct-axis current, the quadrature-axis current, a direct-axis current error value, and a quadrature-axis current error value as observation item of the reinforcement learning algorithm;
using a previous one of the direct-axis voltage and the quadrature-axis voltage as action item of the reinforcement learning algorithm;
calculating a current reward according to a corresponding data of the observation item and the action item based on a reward equation; and
calculating an estimated action item according to the observation item, the current reward, and completed data based on a reinforcement learning control training algorithm, wherein the estimated action item comprises the direct-axis voltage and the quadrature-axis voltage.

13. The motor control device according to claim 12, wherein the reward equation is:
$$rt = - ( Q 1 \times {iderror}^{2} + Q 2 \times {iqerror}^{2} + R \times {\sum }_{j} {( {u}_{t - 1}^{j} )}^{2} )$$
wherein, iderror is the direct-axis current error value, iqerror is the quadrature-axis current error value, Q1, Q2 and R are default parameters, and rt is the current reward.

14. The motor control device according to claim 13, wherein training of the reinforcement learning control training algorithm comprises:
selecting a first action, the first action comprising current state and random noise;
executing a second step, the second step comprising executing the second action to generate an action value, calculating the current reward based on the reward equation, calculating a corresponding state of a next observation item as state data, and storing the current state, the action value, the current reward and the state data as a set of training patterns;
executing the second step multiple times to randomly generate multiple sets of training patterns;
calculating a plurality of value function targets based on the sets of training patterns; and
correcting comment parameters in a neural network based on the sets of training patterns and the value function targets to train the reinforcement learning control training algorithm.

15. The motor control device according to claim 11, wherein the control calculator further comprises:
a pseudo-derivative feedback with feedforward gain controller, coupled to the reinforcement learning controller and calculating the quadrature-axis current command according to the reference rotational speed and the operating speed of the motor.

16. The motor control device according to claim 15, wherein the pseudo-derivative feedback with feedforward gain controller calculates the quadrature-axis current command according to a following equation:
$$iqref = ( Wref - W ) \times ( \frac{KI}{1 - {Z}^{- 1}} + r \times Kpf ) + W \times ( r - 1 ) \times Kpf$$
wherein, W is the operating speed of the motor, Wref is the reference rotational speed, r is a feedforward proportional coefficient, Kpf is a feedback proportional gain, KI is an integral gain, Z⁻¹ is a Z conversion value, and iqref is the quadrature-axis current command.

17. The motor control device according to claim 11, wherein the reinforcement learning algorithm is twin delayed deep deterministic policy gradients (TD3) algorithm.

18. A control method for a motor, comprising:
sensing operating speed and operation angle of the motor;
calculating a direct-axis current and a quadrature-axis current according to a drive current driving the motor and an operating angle;
calculating a direct-axis voltage and a quadrature-axis voltage according to a quadrature-axis current command, the direct-axis current, and the quadrature-axis current by using a reinforcement learning algorithm, wherein the quadrature-axis current command is obtained according to a reference rotational speed and the operating speed of the motor; and
generating a switching signal according to the direct-axis voltage, the quadrature-axis voltage and the operating angle, wherein the switching signal is configured to control a driving circuit to drive the motor.

19. The control method according to claim 18, wherein calculating the direct-axis voltage and the quadrature-axis voltage according to the quadrature-axis current command, the direct-axis current, and the quadrature-axis current by using the reinforcement learning algorithm comprises:
using the direct-axis current, the quadrature-axis current, a direct-axis current error value, and a quadrature-axis current error value as observation item of the reinforcement learning algorithm;
using a previous one of the direct-axis voltage and the quadrature-axis voltage as action item of the reinforcement learning algorithm;
calculating a current reward according to a corresponding data of the observation item and the action item based on a reward equation; and
calculating an estimated action item according to the observation item, the current reward, and completed data based on a reinforcement learning control training algorithm, wherein the estimated action item comprises the direct-axis voltage and the quadrature-axis voltage.

20. The motor control device according to claim 19, wherein training of the reinforcement learning control training algorithm comprises:
selecting a first action, the first action comprising current state and random noise;
executing a second step, the second step comprising executing the second action to generate an action value, calculating the current reward based on the reward equation, calculating a corresponding state of a next observation item as state data, and storing the current state, the action value, the current reward and the state data as a set of training patterns;
executing the second step multiple times to randomly generate multiple sets of training patterns;
calculating a plurality of value function targets based on the sets of training patterns; and
correcting comment parameters in a neural network based on the sets of training patterns and the value function targets to train the reinforcement learning control training algorithm.
